(19) United States
(12) Patent Application Publication
(10) Pub. No.: US 2013/0285923 A1
(43) Pub. Date: Oct. 31, 2013

(54) Digital Dog Tag

(71) Applicant: Genevieve Mariko Wilson, Sherman Oaks, CA (US)

(72) Inventor: Genevieve Mariko Wilson, Sherman Oaks, CA (US)

(21) Appl. No.: 13/456,173

(22) Filed: Apr. 25, 2012

(51) Int. Cl. A01K 11/00; G06F 3/01

(52) U.S. Cl. CPC A01K 11/006; G06F 3/01
USPC 345/173

(57) ABSTRACT

A digital identification tag for storing and displaying identification data is disclosed. The digital identification tag comprises an outer casing having a front portion and a rear portion, a touch screen at the front portion of the outer casing, a circuit board located inside the digital identification tag, a universal serial bus (USB) port, an internal flash memory data storage device mounted on the circuit board, a processor mounted on the circuit board, and a battery holder at the rear portion of the outer casing. The USB port receives identification data from an electronic device. The internal flash memory data storage device stores the identification data received from the USB port. The touch screen displays identification data stored in the internal flash memory data storage device when a user strokes over a top portion and/or a bottom portion of the touch screen.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to pet identification tags, and more particularly to an improved digital pet identification tag having a touch screen display.

### DISCUSSION OF RELATED ART

Pet identification tags have been available in a variety of different styles and designs in the market. These identification tags include information like pet's name, owners' address and phone numbers that make it easy for someone who finds a stray pet to contact the pet owner. The pet identification tags are made of a variety of materials like metals and plastics. Metal tags are engraved with the identification information regarding the pet. The identification tags made of plastics are available in different colors and are highly reflective that makes the strayed pet more visible in dark. However, the engraved information on the metal and plastic tags has a tendency to wear down over time.

One prior art, described in U.S. Pat. No. 6,003,473 issued to Printz describes a pet identification and retrieval device designed to provide information regarding lost pets to individuals who find the pet, and is of compact design, consisting of a front half enclosure and rear half enclosure. The front half enclosure contains a play switch, a speaker opening and a low battery indicator. The rear half enclosure contains a recessed recording switch and a permanent identification plate. The permanent identification plate is engraved with the identification information of the pet. However, the permanent identification plate is made of metal and has a tendency to wear and become unreadable.

U.S. Pat. No. 6,568,354 issued to Wasserman describes a pet identification tag with an electronic display that would display pet owner identification information and pertinent information of the pet. The pet identification tag includes scroll buttons designed to display the identification information when pressed. The pet identification tag is small in size and readily mountable on an exterior structure, such as a dog or cat collar. However, the position of the scroll buttons does not provide a clear operating characteristic to an individual who finds the strayed pet and hence the tag is not user friendly.

U.S. Pat. No. 6,885,305 issued to Davis describes a system for locating and sending messages to pets. The system allows sending messages to a pet using a hand-held remote transmitter and a receiver that is attached to the pet. The receiver can record voice commands. When the transmitter sends a signal, the receiver picks up the signal and plays the recorded command to the pet. Such a device causes the pet to suffer from radiations from the signals sent by the transmitter.

Therefore, there is a need for a device that would provide a pet identification tag that is easy to operate. Such a needed device would not cause the pet to suffer from signal radiations. Further, such a device would be made of a durable material. The present invention accomplishes these objectives.

### SUMMARY OF THE INVENTION

The present invention is a digital identification tag for storing and displaying identification data. The digital identification tag comprises an outer casing having a front portion and a rear portion, a touch screen at the front portion of the outer casing, a circuit board located inside the digital identification tag, a universal serial bus (USB) port, an internal flash memory data storage device mounted on the circuit board, a processor mounted on the circuit board and a battery holder at the rear portion of the outer casing. The internal flash memory data storage device stores the identification data received from the USB port. The touch screen includes a top portion and a bottom portion. The touch screen displays the identification data stored in the internal flash memory data storage device when a user strokes over the top portion and/or the bottom portion of the touch screen. The top portion displays text information and the bottom portion displays picture information.

The circuit board is adaptable to operate with the touch screen. The processor is installed with a dedicated software to manage the identification data. The internal flash memory data storage device stores the identification data of at least one pet. The digital identification tag includes a unique code. The electronic device is installed with a software means compatible with the dedicated software. The digital identification tag utilizes a USB cable to transfer the identification data from the electronic device to the internal flash memory data storage device. The electronic device may be selected from a group consisting of computer system, mobile phone and I-Phone. The touch screen may be a touch organic light emitting diode (OLED) screen.

The present invention facilitates an efficient way for storing and displaying identification information of a pet using a digital identification tag. Such a needed device does not cause the pet to suffer from signal radiations. Further, such a device is made of a durable material. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a front view of the invention, illustrating a digital identification tag;

FIG. 2 is a perspective view of the invention, illustrating the digital identification tag connected with an electronic device;

FIG. 3 is a perspective view of the invention, illustrating the digital identification tag in a stand-by mode;

FIG. 4 is a perspective view of the invention, illustrating a rear portion of the digital identification tag;

FIG. 5 is a side perspective view of the digital identification tag; and

FIG. 6 is a perspective view of the invention, illustrating the digital identification tag worn by at least one pet.

### DETAILED DESCRIPTION OF THE PREFERRED EMBODIMENT

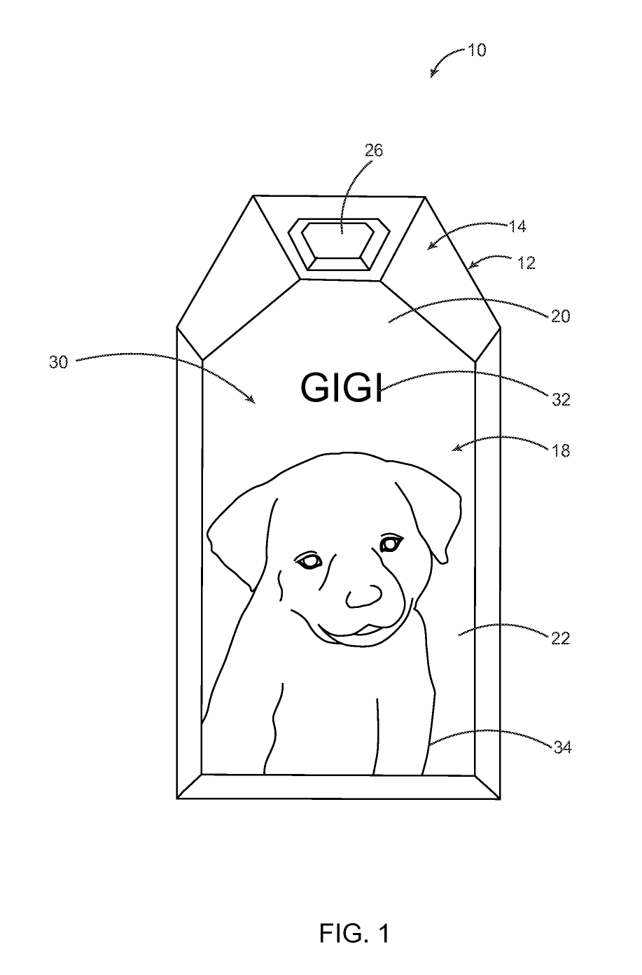

FIG. 1 is a front view of a digital identification tag 10 for storing and displaying identification data 30. The digital identification tag 10 comprises an outer casing 12 having a front portion 14 and a rear portion (not shown), a touch screen 18 at the front portion 14 of the outer casing 12, a circuit board (not shown) located inside the digital identification tag 10, a universal serial bus (USB) port (not shown), an internal flash memory data storage device (not shown) mounted on the circuit board (not shown), a processor (not shown) mounted on the circuit board, and a battery holder (not shown) at the rear portion (not shown) of the outer casing 12. The USB port (not shown) located at a peripheral edge (not shown) of the digital identification tag 10 is designed to receive the identification data 30 from an electronic device (not shown). The internal flash memory data storage device (not shown) stores the identification data 30 received from the USB port (not shown). The touch screen 18 includes a top portion 20 and a bottom portion 22. The touch screen 18 displays the identification data 30 stored in the internal flash memory data storage device (not shown) when a user strokes over the top portion 20 and/or the bottom portion 22 of the touch screen 18. The identification data 30 includes text information 32 and picture information 34. The top portion 20 displays the text information 32 and the bottom portion 22 displays the picture information 34. The user touches the top portion 20 of the touch screen 18 to scroll between the text information 32 and the bottom portion 22 to scroll between the picture information 34.

The digital identification tag 10 includes a hole 26 at the front portion 14 for securely connecting the digital identification tag 10 with a pet collar (not shown) of at least one pet (not shown). The circuit board (not shown) is adaptable to operate with the touch screen 18. The processor (not shown) is installed with a dedicated software to manage the identification data 30. The internal flash memory data storage device (not shown) stores the identification data 30 of the at least one pet (not shown). The identification data 30 includes details of the at least one pet (not shown) like name, health information and photo and details of owner of the at least one pet (not shown) like address, telephone number and e-mail address. The digital identification tag 10 includes a unique code.

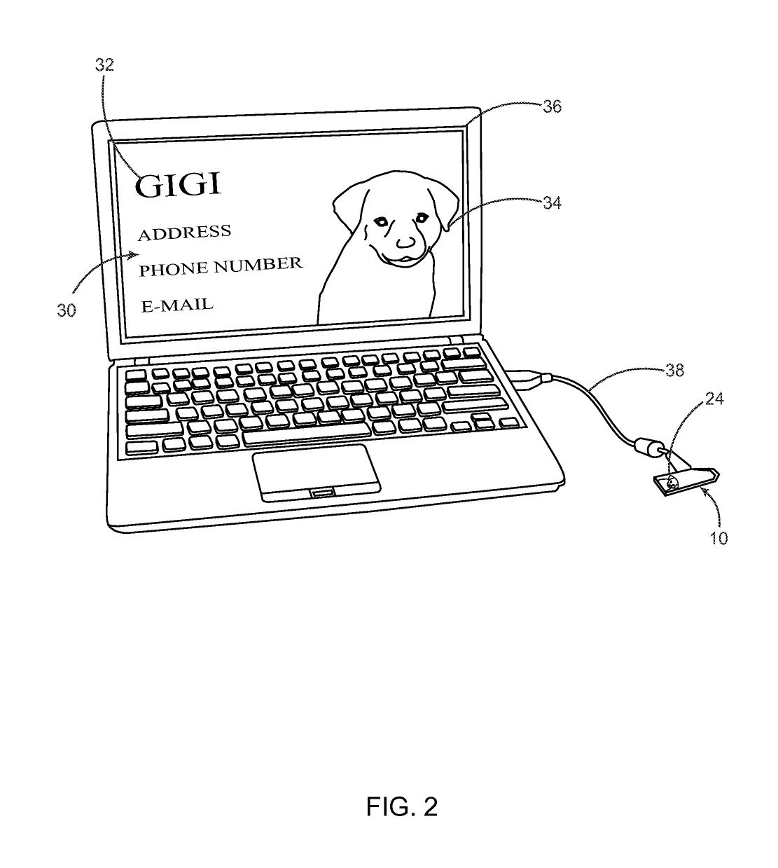

FIG. 2 shows the digital identification tag 10 connected to the electronic device 36. The electronic device 36 is installed with a software means compatible with the dedicated software in the processor (not shown). The digital identification tag 10 utilizes a USB cable 38 to transfer the identification data 30 from the electronic device 36 to the internal flash memory data storage device (not shown). The USB port (not shown) located at the peripheral edge 24 of the digital identification tag 10 may be a micro-B USB port. The identification data 30 can be transferred from the electronic device 36 to the digital identification tag 10 through Infrared, Bluetooth or email. The electronic device 36 may be selected from a group consisting of computer system, mobile phone and I-Phone. The outer casing 12 of the digital identification tag 10 is made of plastic material. The touch screen 18 may be a touch organic light emitting diode (OLED) screen.

The user is allowed to upload the identification data 30 in the electronic device 36 using a link program. When the user connects the digital identification tag 10 to the electronic device 36 for the first time, the link program activates a website for creating at least one identification account for the at least one pet (not shown). Upon creating the at least one identification account, the user fills an information template and upload pictures 34 of the at least one pet in the website. The uploaded information associated with the at least one identification account is saved in the website and transferred to the internal flash memory data storage device (not shown) through the USB cable 38.

The user is able to update the identification data 30 associated with the at least one identification account. To update the identification data 30 the identification tag 10 is again connected to the electronic device 36 and the at least one identification account is accessed using the unique code of the identification tag 10. Only the owner of the at least one pet has access to the unique code. When the identification data 30 is uploaded or updated the digital identification tag 10 becomes active with the touch screen 18 turned on. In the active state, a blinking symbol is displayed on the touch screen 18 to indicate a data transfer or data read and/or write.

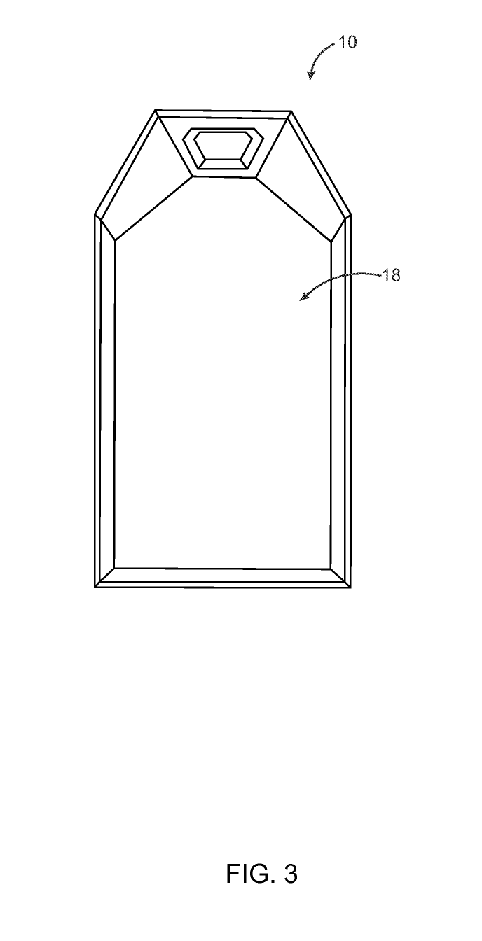

Referring to FIG. 3, the digital identification tag 10 in a stand-by mode is illustrated. When the digital identification tag 10 is not functioning, it will be in the stand-by mode with the touch screen 18 turned off. When the touch screen 18 is touched, the tag becomes activated and the touch screen 18 turns on displaying home page of the website. The digital identification tag 10 remains active as long as the user is browsing between the identification data 30 stored in the digital identification tag 10. When the user stops browsing, the digital identification 10 goes back to the stand-by mode in a pre-selected number of seconds. The purpose of the stand-by mode is to extend the battery lifetime, while not exposing the identification data 30 at all time and to provide the digital identification tag 10 a more aesthetic look.

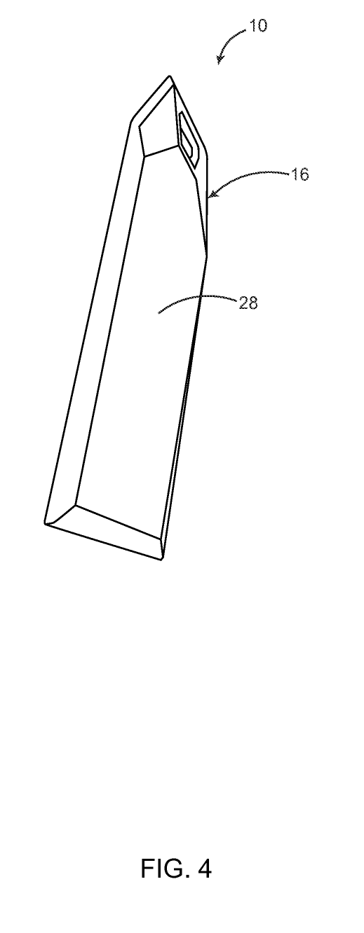

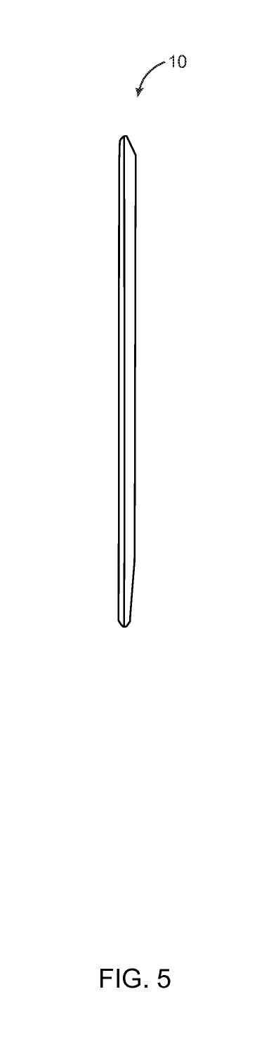

FIG. 4 shows a perspective view of the rear portion 16 of the digital identification tag 10. The rear portion 16 of the digital identification tag 10 includes a battery holder 28 to store at least one battery (not shown). FIG. 5 illustrates a side perspective view of the digital identification tag 10.

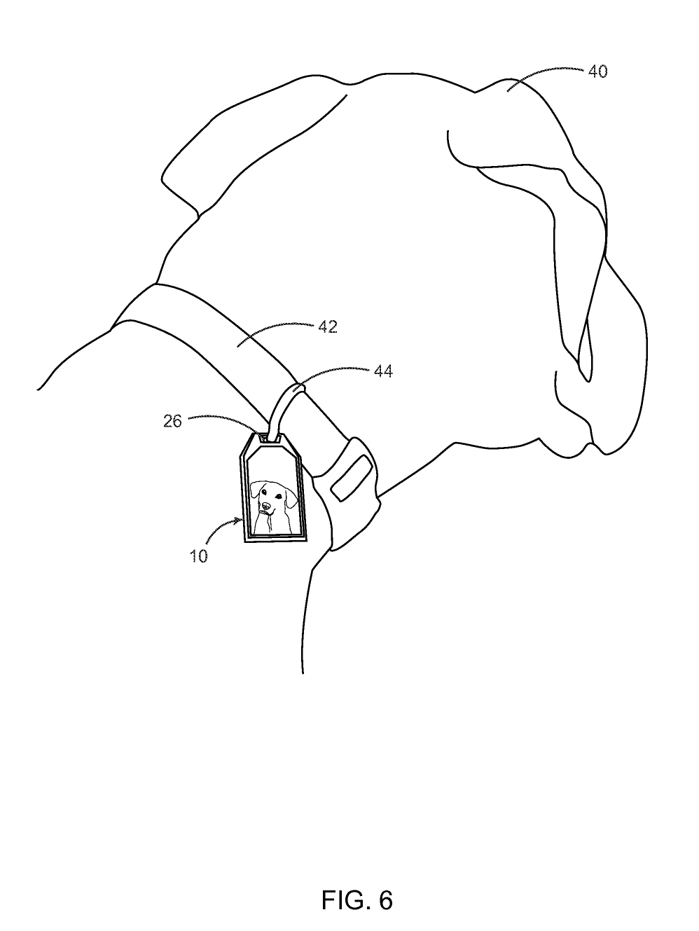

FIG. 6 illustrates the digital identification tag 10 worn on a pet collar 42 of the at least one pet 40. The hole 26 connects the digital identification tag 10 with a connecting means 44 of the pet collar 42. With slightly different modifications, the digital identification tag 10 may be used for senior citizens with dementia, regular kids and mentally disabled children and adults. Additionally, the tag may be used on luggage or other types of bags for the purpose of identification.

While a particular form of the invention has been illustrated and described, it will be apparent that various modifications can be made without departing from the spirit and scope of the invention. For example, the digital identification device 10 may include a small speaker to play a recorded spoken message. Likewise, the digital identification tag 10 may include a device to protect the at least one pet 40 against electro magnetic radiation (EMR). Accordingly, it is not intended that the invention be limited, except as by the appended claims.

What is claimed is:

1. A digital identification tag, comprising:
an outer casing having a front portion and a rear portion;
a touch screen at the front portion of the outer casing, the touch screen includes a top portion and a bottom portion;
a circuit board located inside the digital identification tag, the circuit board being adaptable to operate with the touch screen;
a universal serial bus (USB) port designed to receive identification data from an electronic device, the USB port being located at a peripheral edge of the digital identification tag;
an internal flash memory data storage device mounted on the circuit board to store the identification data received from the USB port;
a processor mounted on the circuit board, the processor being installed with a dedicated software to manage the identification data; and
a battery holder at the rear portion of the outer casing;
whereby the touch screen displays the identification data stored in the internal flash memory data storage device when a user strokes over the top portion and/or the bottom portion of the touch screen.

2. The digital identification tag of claim 1 wherein the internal flash memory data storage device stores the identification data of at least one pet.

3. The digital identification tag of claim 1 wherein the identification data may include name, address, telephone number, e-mail address, health information and photo.

4. The digital identification tag of claim 1 wherein the top portion of the touch screen displays text information and the bottom portion thereof displays picture information.

5. The digital identification tag of claim 1 wherein the touch screen may be a touch organic light emitting diode (OLED) screen.

6. The digital identification tag of claim 1 wherein the USB port may be a micro-B USB port.

7. The digital identification tag of claim 1 wherein the digital identification tag includes a unique code.

8. The digital identification tag of claim 1 wherein the battery holder stores at least one battery.

9. The digital identification tag of claim 1 wherein the electronic device is installed with a software means compatible with the dedicated software.

10. The digital identification tag of claim 9 wherein the software means is utilized to create at least one identification account for the at least one pet in a website.

11. The digital identification tag of claim 10 wherein the at least one identification account may be accessed using the unique code associated with the digital identification tag.

12. The digital identification tag of claim 1 wherein the electronic device may be selected from a group consisting of computer system, mobile phone and I-Phone.

13. The digital identification tag of claim 1 wherein the outer casing of the digital identification tag may be made of plastic material.

14. A method for storing and displaying identification data utilizing a digital identification tag, the method comprising:
a) providing the digital identification tag;
b) connecting the digital identification tag to the electronic device having a software means compatible with a dedicated software;
c) activating a website utilizing a link program;
d) creating at least one identification account in the website;
e) entering the identification data by filling an information template and uploading at least one picture associated with the at least one identification account;
f) saving the identification data in the website;
g) transferring the identification data to the digital identification tag;
h) storing the identification data in an internal flash memory data storage device in the digital identification tag; and
i) stroking over a touch screen of the digital identification tag to display the identification data in the touch screen.

15. The method of claim 14 wherein the touch screen includes a top portion and a bottom portion.

16. The method of claim 14 wherein the top portion of the touch screen displays text information and the bottom portion thereof displays picture information.

17. The method of claim 14 wherein the internal flash memory data storage device stores the identification data of at least one pet.

18. The method of claim 14 wherein the digital identification tag includes a processor having the dedicated software.

19. The method of claim 14 wherein the digital identification tag includes a unique code.

20. The method of claim 14 wherein the link program is utilized to access the website.

21. The method of claim 14 wherein the digital identification tag includes a universal serial bus (USB) port to connect the digital identification tag to the electronic device.

22. The method of claim 14 wherein a user is allowed to edit identification information stored in the internal flash memory data storage device.

23. The method of claim 14 wherein the electronic device may be selected from a group consisting of computer system, mobile phone and I-Phone.
